(19) United States
(12) Patent Application Publication
(10) Pub. No.: US 2020/0400246 A1
(43) Pub. Date: Dec. 24, 2020

(54) SOLENOID VALVE FOR IRRIGATION SYSTEM

(71) Applicant: Chin-Yuan Chen, Changhua (TW)

(72) Inventor: Chin-Yuan Chen, Changhua (TW)

(73) Assignee: SHIN TAI SPURT WATER OF THE GARDEN TOOLS CO., LTD., Changhua (TW)

(21) Appl. No.: 16/450,731

(22) Filed: Jun. 24, 2019

(51) Int. Cl. F16K 31/06; F16K 7/16

(52) U.S. Cl. CPC F16K 31/0672; F16K 7/16

(57) ABSTRACT

A solenoid valve for irrigation system may include a gardening tube, a rubber valve piece, a cover, and a valve column. The gardening tube has a water inlet channel and a water outlet channel which are communicated, and a valve tube vertically extends from the gardening tube. A vertical first connecting tube is formed inside the valve tube. The valve piece is movable in the valve tube to abut against the first connecting tube. The cover comprises a second connecting tube vertically protruding from the cover, and the second connecting tube has a valve chamber formed at a first end thereof which is communicated with the valve tube. The valve column arranged in the valve chamber of the second connecting tube has a tapered end faced to the valve piece.

### FIELD OF THE INVENTION

The present invention relates to a solenoid valve and more particularly to a solenoid valve for irrigation system having high operation stability and high assembly yield rate.

### BACKGROUND OF THE INVENTION

Referring to FIGS. 8 and 9, a conventional solenoid valve for irrigation systems comprises a connecting tube (50), a valve piece (60) and a solenoid valve (70). The connecting tube (50) has a water inlet tube (52) and a water outlet tube (53), and a valve tube (51) is formed therebetween and configured to separate the water inlet tube (52) and the water outlet tube (53). The valve piece (60) installed in the valve tube (51) is configured to control water flow passing from the water inlet tube (52) to the water outlet tube (53). The solenoid valve (70) has a magnetic member (71) installed therein, and a metal plate (72) is installed at an end of the solenoid valve (70) which is located away from the valve piece (60). Moreover, the valve piece (60) is connected to a metal ring (61). When the solenoid valve (70) is energized to generate magnetic field which pushes the magnetic member (71) to bear against the valve piece (60), the valve piece (60) is configured to tightly press the valve tube (51) so as to stop water flowing from the water inlet tube (52) to the water outlet tube (53). Meanwhile, the magnetic member (71) is adapted to stick to the metal ring (61) of the valve piece (60). On the other hand, when reverse current is provided to pass through the solenoid valve (70), the magnetic member (71) is configured to detach from the valve piece (60) and to move toward and stick to the metal plate (72) of the solenoid valve (70) so as to enable water to flow from the water inlet tube (52) to the water outlet tube (53).

However, the conventional solenoid valve for irrigation system has following disadvantages: (i) more electricity is needed not only in detaching the magnetic member (71) from the metal ring (61) or the metal plate (72) but also in keeping pushing the magnetic member (71) to abut against the valve piece (60) after the magnetic member (71) is detached from the metal plate (72), and also the solenoid valve (70) needs to keep energized, otherwise the weight of the magnetic member (71) is not enough to support the valve piece (60) and stop the water pressure, which consumes a large amount of power; and (ii) on the other hand, the solenoid valve (70) is not energized that can only reduce the support force of the magnetic member (71), rather than detach the magnetic member (71) from the valve piece (60), which is insufficient in operation stability of water inlet and water outlet. Therefore, there remains a need for a new and improved design for a solenoid valve for irrigation system to overcome the problems presented above.

### SUMMARY OF THE INVENTION

The present invent provides a solenoid valve for irrigation system which comprises a gardening tube, a rubber valve piece, a cover, and a valve column. The gardening tube has a water inlet channel and a water outlet channel which are communicated with each other, and a valve tube vertically extending from the gardening tube comprises an opening, and a connecting annular groove is formed at an edge of the opening of the valve tube. A vertical first connecting tube is formed inside the valve tube. The water inlet channel and the water outlet channel are respectively communicated with an outside and an inside of the first connecting tube, and the water inlet channel and the water outlet channel are communicated through the valve tube. A first annular groove is formed on an inner wall of the valve tube, and the valve piece is coupled with the valve tube through the first annular groove. The valve piece is movable in the valve tube to abut against the first connecting tube. The cover comprises an annular first protruding edge and an annular second protruding edge which respectively protrude from a lower surface of the cover, and the second protruding edge is located farther from the center of the cover than the first protruding edge. The cover is coupled on the valve tube so as to enable the second protruding edge downwardly abut against an outer periphery of the valve piece. The first protruding edge coupled in the connecting annular groove is secured with the connecting annular groove through high-frequency adhesive process to form sealing. The cover comprises a second connecting tube vertically protruding from the cover, and the second connecting tube has a valve chamber formed at a first end thereof which is communicated with the valve tube. A housing formed at a second end of the second connecting tube is adapted to accommodate a magnetic member, and a cap is configured to couple with the second end of the second connecting tube to block an opening of the housing. A solenoid coil is disposed on an outer periphery of the second connecting tube. The valve column arranged in the valve chamber of the second connecting tube has a tapered end faced to the valve piece. The solenoid coil is energized to generate a magnetic field in one direction or in an opposed direction so as to move the valve column downwardly or upwardly in the valve chamber such that the tapered end of the valve column is configured to abut against the valve piece to block water or to move away from the valve piece to enable water to pass through the first connecting tube.

In one embodiment, the valve piece comprises a water stopper, a flexible ring, and a first locating ring which are formed radially from the center of the valve piece, and the valve piece is connected to the first annular groove through the first locating ring, and the flexibility of the flexible ring enables the water stopper to flexibly abut against the first connecting tube.

In another embodiment, a through hole axially penetrates through the water stopper, and the tapered end of the valve column is configured to abut against the through hole to block water; when the tapered end is detached from the through hole, the through hole is adapted to enable water to pass therethrough.

In still another embodiment, an end of the valve column, which is faced to the magnetic member, has a slot, and a coiled compression spring is disposed in the slot, and the compression spring is coupled between the valve column and the second connecting tube so as to increase the downward force of the valve column exerted on the valve piece.

In a further embodiment, the depth of the slot is longer than half length of the compression spring so as to avoid the deformation of the compression spring and improve the performance of the compression spring.

In still a further embodiment, a non-metal ring is coupled with the water stopper to improve the hardness of the water stopper so as to enable the water stopper to evenly abut against the first connecting tube.

In a particular embodiment, the non-metal ring is made of plastic, ceramic, glass or acrylic.

In an advantageous embodiment, an annular beveled edge formed at an opening of the first connecting tube is cooperated with the water stopper to form sealing, thereby improving the water sealing effect.

In a preferred embodiment, the cover and the cap are secured together through high-frequency adhesive process.

Comparing with conventional solenoid valve for irrigation system, the present invention is advantageous because: (i) the slot of the valve column is adapted to receive the compression spring, and the valve column is positioned in the valve chamber of the second connecting tube, and the compression spring is coupled between the valve column and the second connecting tube, so that the elastic force of the compression spring can cooperate the magnetic force generated from the solenoid coil to move the valve column toward the valve piece; and (ii) the depth of the slot is longer than half length of the compression spring so as to avoid the deformation of the compression spring and improve the performance of the compression spring.

### BRIEF DESCRIPTION OF THE DRAWINGS

FIG. 1 is a three-dimensional assembly view of a solenoid valve for irrigation system of the present invention.

FIG. 2 is a three-dimensional exploded view of the solenoid valve for irrigation system of the present invention.

FIG. 3 is a partial sectional view of the solenoid valve for irrigation system of the present invention.

FIG. 4 is a schematic view illustrating a gardening tube of the present invention is turned off.

FIG. 5 is a schematic view illustrating the gardening tube of the present invention is turned on.

FIG. 6 is a prior art.

FIG. 7 is a prior art.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

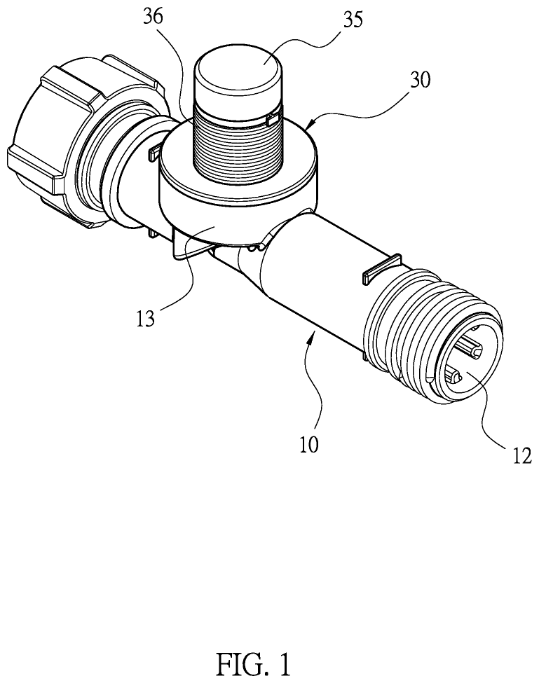

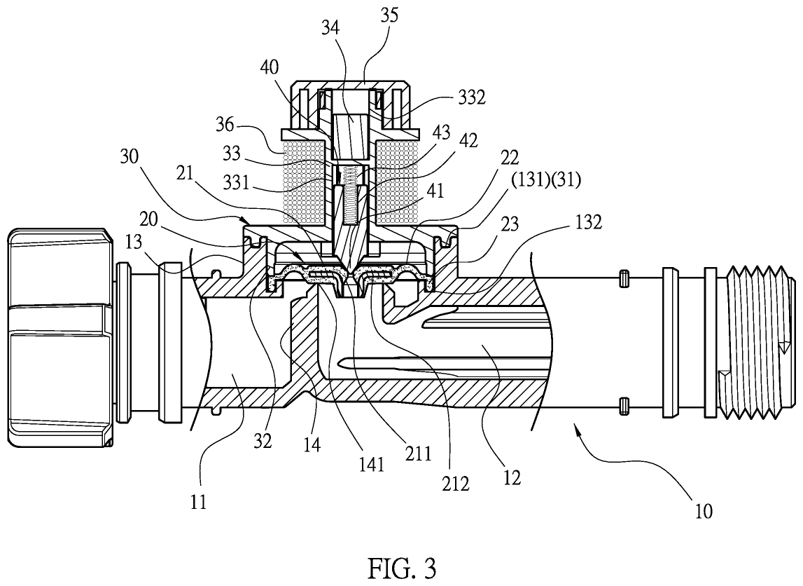

Referring to FIGS. 1 to 3, the present invention provides a solenoid valve for irrigation system which comprises a gardening tube (10), a rubber valve piece (20), a cover (30), and a valve column (40). The gardening tube (10) has a water inlet channel (11) and a water outlet channel (12) which are communicated with each other, and a valve tube (13) vertically extending from the gardening tube (10) comprises an opening, and a connecting annular groove (131) is formed at an edge of the opening of the valve tube (13). Moreover, a vertical first connecting tube (14) is formed inside the valve tube (13). The water inlet channel (11) and the water outlet channel (12) are respectively communicated with an outside and an inside of the first connecting tube (14), and the water inlet channel (11) and the water outlet channel (12) are communicated through the valve tube (13). A first annular groove (132) is formed on an inner wall of the valve tube (13), and the valve piece (20) is coupled with the valve tube (13) through the first annular groove (132). Furthermore, the valve piece (20) is movable in the valve tube (13) to abut against the first connecting tube (14). The valve piece (20) comprises a water stopper (21), a flexible ring (22), and a first locating ring (23) which are formed radially from the center of the valve piece (20), and the valve piece (20) is connected to the first annular groove (132) through the first locating ring (23). The flexibility of the flexible ring (22) enables the water stopper (21) to flexibly abut against the first connecting tube (14). A through hole (211) axially penetrates through the water stopper (21), and a non-metal ring (212) is coupled with the water stopper (21) to improve the hardness of the water stopper (21) so as to enable the water stopper (21) to evenly abut against the first connecting tube (14). The non-metal ring (212) is made of plastic, ceramic, glass or acrylic. An annular beveled edge (141) formed at an opening of the first connecting tube (14) is cooperated with the water stopper (21) to form an annular sealing, thereby improving the water sealing effect. The cover (30) comprises an annular first protruding edge (31) and an annular second protruding edge (32) which respectively protrude from a lower surface of the cover (30), and the second protruding edge (32) is located farther from the center of the cover (30) than the first protruding edge (31). The cover (30) is coupled on the valve tube (13) so as to enable the second protruding edge (32) downwardly abut against an outer periphery of the valve piece (20). The first protruding edge (31) is coupled in the connecting annular groove (131), and the first protruding edge (31) is secured with the connecting annular groove (131) through high-frequency adhesive process to form sealing. The cover (30) comprises a second connecting tube (33) vertically protruding from the cover (30), and the second connecting tube (33) has a valve chamber (331) formed at a first end thereof which is communicated with the valve tube (13). A housing (332) formed at a second end of the second connecting tube (33) is adapted to accommodate a magnetic member (34), and a cap (35) is configured to couple with the second end of the second connecting tube (33) to block an opening of the housing (332). The cover (30) and the cap (35) are secured together through high-frequency adhesive process, and a solenoid coil (36) is disposed on an outer periphery of the second connecting tube (33). The valve column (40) arranged in the valve chamber (331) of the second connecting tube (33) has a tapered end (41) faced to the valve piece (20) so as to abut against the through hole (211). Moreover, when the tapered end (41) is detached from the through hole (211), the through hole (211) is adapted to enable water to pass therethrough. An end of the valve column (40), which is faced to the magnetic member (34), has a slot (42), and a coiled compression spring (43) is disposed in the slot (42). The compression spring (43) is coupled between the valve column (40) and the second connecting tube (33) so as to increase the downward force of the valve column (40) exerted on the valve piece (20). The depth of the slot (42) is longer than half length of the compression spring (43) so as to avoid the deformation of the compression spring (43) and improve the performance of the compression spring (43). The solenoid coil (36) is adapted to generate a magnetic field in one direction or a magnetic field in an opposed direction so as to move the valve column (40) downwardly or upwardly in the valve chamber (331) such that the tapered end (41) of the valve column (40) is configured to abut against the valve piece (20) to block water or to move away from the valve piece (20) to enable water to pass through the first connecting tube (14).

Structurally, referring to FIGS. 1 to 3, the solenoid coil (36) is disposed on the outer periphery of the second connecting tube (33), and the magnetic member (34) is positioned in the housing (332) of the second connecting tube (33). The cap (35) is coupled with the second end of the second connecting tube (33) to block the opening of the housing (332) so as to prevent the magnetic member (34) from falling out of the housing (332). Moreover, the cover (30) and the cap (35) are secured together through high-frequency adhesive process, and the compression spring (43) is positioned in the slot (42) of the valve column (40). The valve column (40) is positioned in the valve chamber (331) through the end thereof having the slot (42), and the compression spring (43) is coupled between the second connecting tube (33) and the valve column (40). Furthermore, the valve piece (20) is disposed in the valve tube (13) of the gardening tube (10), and the first locating ring (23) is engaged with the first annular groove (132) of the valve tube (13). The water stopper (21) is coupled at an upper end of the first connecting tube (14), and the cover (30) blocks the opening of the valve tube (13). In addition, the second protruding edge (32) is inserted into the valve tube (13) to downwardly press the first locating ring (23) of the valve piece (20) so as to secure the position of the valve piece (20) through the first annular groove (132) and the second protruding edge (32). Also, the compression spring (43) is adapted to push the valve column (40), and the tapered end (41) of the valve column (40) is abutted against the through hole (211) of the valve piece (20). The first protruding edge (31) of the cover (30) is coupled in the connecting annular groove (131) of the valve tube (13) to form a non-coplanar connection which has larger contact areas. The first protruding edge (31) is secured with the connecting annular groove (131) through high-frequency adhesive process such that the cover (30) and the valve tube (13) can be quickly connected without rotating the second protruding edge (32) and the valve piece (20), thereby improving the sealing effect of the solenoid valve of the present invention.

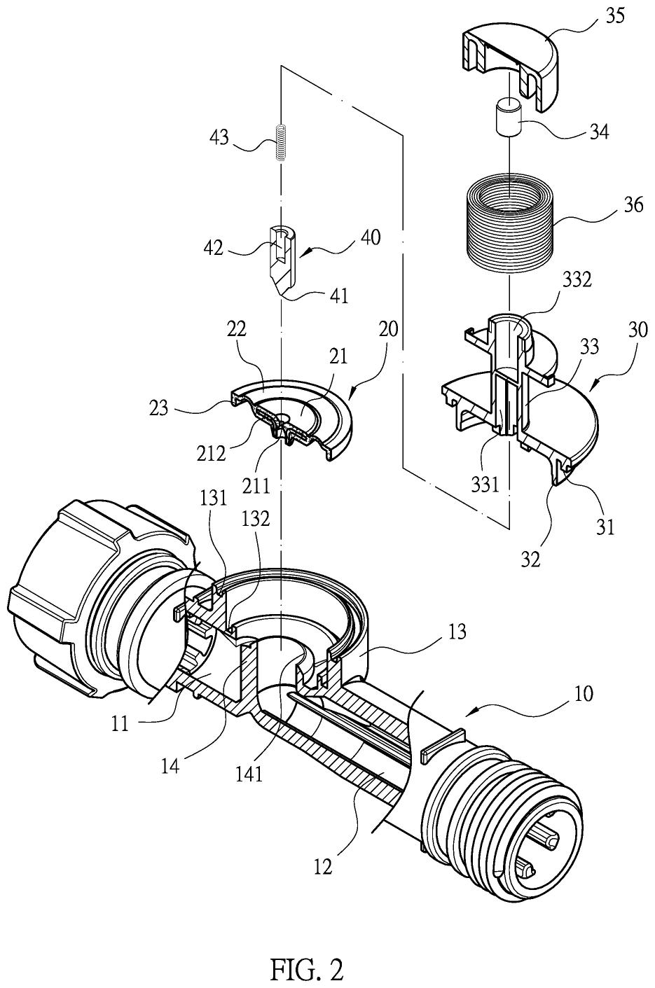

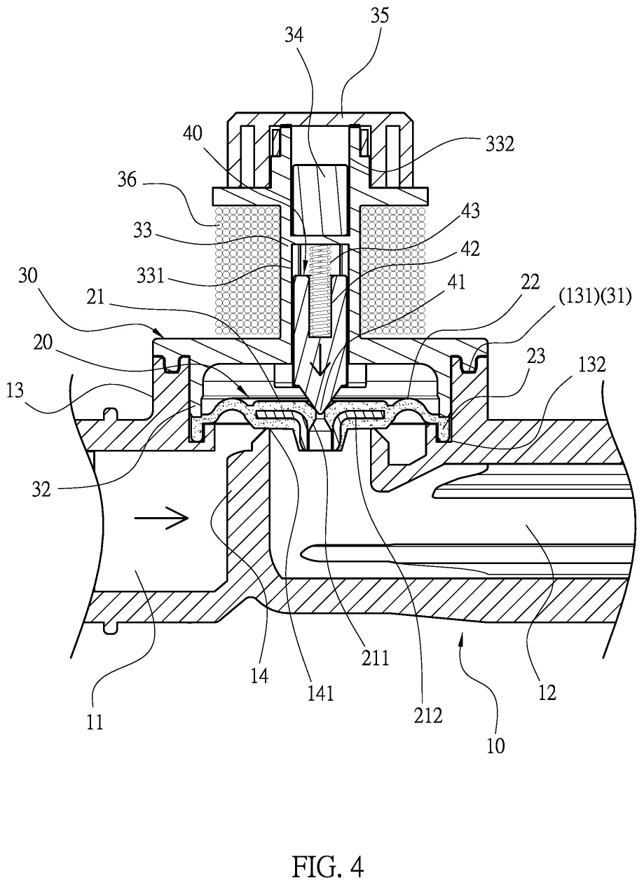

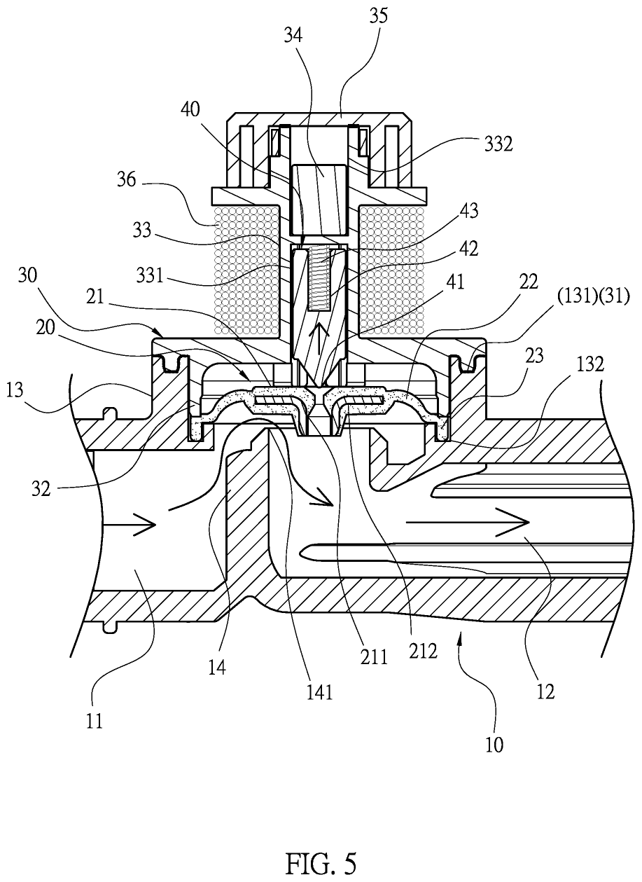

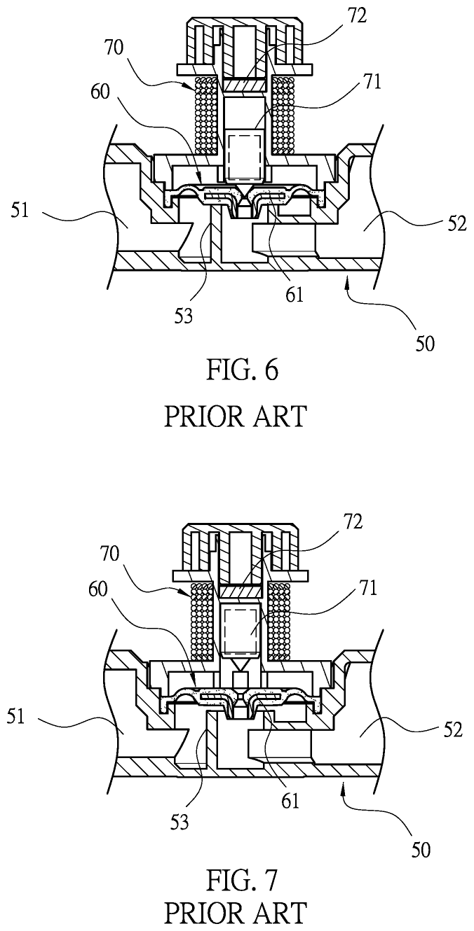

In actual application, referring to FIGS. 2, 4, and 5, the valve column (40) is made of metal. In case that the gardening tube (10) needs to be turned off, the solenoid coil (36) is energized to move the valve column (40) downwardly, and the valve column (40) is adapted to press against the through hole (211) of the valve piece (20), and the valve piece (20) is configured to abut against the beveled edge (141) of the first connecting tube (14) so as to block water from passing from the water inlet channel (11) to the water outlet channel (12). Then, when the solenoid coil (36) returns to non-energized status, the valve column (40) is pushed by the compression spring (43) so as to keep the position of the valve piece (20) without power consumption.

In case that the gardening tube (10) needs to be turned on, the solenoid coil (36) is adapted to be energized to move the valve column (40) upwardly, and the valve column (40) is adapted to overcome the elastic force of the compression spring (43) and move toward the magnetic member (34). Thereafter, the valve piece (20) is configured to be pushed by the water pressure from the water inlet channel (11) and be detached from the first connecting tube (14), and water is adapted to flow from the water inlet channel (11) through the valve tube (13), the first connecting tube (14) and out of the water outlet channel (12), thereby achieving the irrigation effect. After that, when the solenoid coil (36) returns to non-energized status, the magnetic force of the magnetic member (34) is adapted to overcome the elastic force of the compression spring and magnetically attract the valve column (40) at a position that enables the gardening tube (10) to keep turn-on, thereby saving power.

Comparing with conventional solenoid valve for irrigation system, the present invention is advantageous because: (i) the slot (42) of the valve column (40) is adapted to receive the compression spring (43), and the valve column (40) is positioned in the valve chamber (331) of the second connecting tube (33), and the compression spring (43) is coupled between the valve column (40) and the second connecting tube (33), so that the elastic force of the compression spring (43) can cooperate the magnetic force generated from the solenoid coil (36) to move the valve column (40) toward the valve piece (20); and (ii) the depth of the slot (42) is longer than half length of the compression spring (43) so as to avoid the deformation of the compression spring (43) and improve the performance of the compression spring (43).

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A solenoid valve for irrigation system comprising a gardening tube, a rubber valve piece, a cover, and a valve column;
wherein the gardening tube has a water inlet channel and a water outlet channel which are communicated with each other, and a valve tube vertically extending from the gardening tube comprises an opening, and a connecting annular groove is formed at an edge of the opening of the valve tube, and a vertical first connecting tube is formed inside the valve tube; the water inlet channel and the water outlet channel are respectively communicated with an outside and an inside of the first connecting tube, and the water inlet channel and the water outlet channel are communicated through the valve tube; a first annular groove is formed on an inner wall of the valve tube;
wherein the valve piece coupled with the valve tube through the first annular groove is movable in the valve tube to abut against the first connecting tube;
wherein the cover comprises an annular first protruding edge and an annular second protruding edge which respectively protrude from a lower surface of the cover, and the second protruding edge is located farther from the center of the cover than the first protruding edge; the cover is coupled on the valve tube so as to enable the second protruding edge downwardly abut against an outer periphery of the valve piece; the first protruding edge coupled in the connecting annular groove is secured with the connecting annular groove through high-frequency adhesive process to form sealing; the cover comprises a second connecting tube vertically protruding from the cover, and the second connecting tube has a valve chamber formed at a first end thereof which is communicated with the valve tube; a housing formed at a second end of the second connecting tube is adapted to accommodate a magnetic member, and a cap is configured to couple with the second end of the second connecting tube to block an opening of the housing; a solenoid coil is disposed on an outer periphery of the second connecting tube; and
wherein the valve column arranged in the valve chamber of the second connecting tube has a tapered end faced to the valve piece; the solenoid coil is energized to generate a magnetic field in one direction or in an opposed direction so as to move the valve column downwardly or upwardly in the valve chamber such that the tapered end of the valve column is configured to abut against the valve piece to block water or to move away from the valve piece to enable water to pass through the first connecting tube.

2. The solenoid valve for irrigation system of claim 1, wherein the valve piece comprises a water stopper, a flexible ring, and a first locating ring which are formed radially from the center of the valve piece, and the valve piece is connected to the first annular groove through the first locating ring, and the flexibility of the flexible ring enables the water stopper to flexibly abut against the first connecting tube.

3. The solenoid valve for irrigation system of claim 2, wherein a through hole axially penetrates through the water stopper, and the tapered end of the valve column is configured to abut against the through hole to block water; when the tapered end is detached from the through hole, the through hole is adapted to enable water to pass therethrough.

4. The solenoid valve for irrigation system of claim 1, wherein an end of the valve column, which is faced to the magnetic member, has a slot, and a coiled compression spring is disposed in the slot, and the compression spring is coupled between the valve column and the second connecting tube so as to increase the downward force of the valve column exerted on the valve piece.

5. The solenoid valve for irrigation system of claim 1, wherein the depth of the slot is longer than half length of the compression spring so as to avoid the deformation of the compression spring and improve the performance of the compression spring.

6. The solenoid valve for irrigation system of claim 1, wherein a non-metal ring is coupled with the water stopper to improve the hardness of the water stopper so as to enable the water stopper to evenly abut against the first connecting tube.

7. The solenoid valve for irrigation system of claim 6, wherein the non-metal ring is made of plastic, ceramic, glass or acrylic.

8. The solenoid valve for irrigation system of claim 1, wherein an annular beveled edge formed at an opening of the first connecting tube is cooperated with the water stopper to form sealing, thereby improving the water sealing effect.

9. The solenoid valve for irrigation system of claim 1, wherein the cover and the cap are secured together through high-frequency adhesive process.
